(19) United States
(12) Patent Application Publication
(10) Pub. No.: US 2019/0011185 A1
(43) Pub. Date: Jan. 10, 2019

(54) SHAFT FURANCE CONSTRUCTION METHOD AND ASSEMBLY

(71) Applicant: DANIELI CORUS B.V., Velsen Noord (NL)

(72) Inventors: Joep Grippeling, Rooswijkweg 291 (NL); Maurice Groen, Rooswijkweg 291 (NL); Magnus Sarbrant, Rooswijkweg 291 (NL); Victor Van Straaten, Rooswijkweg 291 (NL)

(73) Assignee: DANIELI CORUS B.V., Velsen Noord (NL)

(21) Appl. No.: 16/066,581

(22) PCT Filed: Dec. 29, 2016
(86) PCT No.: PCT/EP2016/082895

§ 371 Date: Jun. 27, 2018

(30) Foreign Application Priority Data
Dec. 30, 2015 (EP) 15203208.2

(51) Int. Cl. F27D 1/16; C21B 7/00

(52) U.S. Cl. CPC F27D 1/1621; C21B 7/00

(57) ABSTRACT

A method of constructing a shaft furnace is provided, as well as an assembly and a fixation structure therefor. The method comprises the steps of providing on a first position a furnace segment comprising a ring wall extending along a central axis, and transporting the segment to a second position and operably attaching the segment there to one or more further blast furnace portions. The method further comprises that during said transporting the segment to the second position the segment comprises at least one fixation structure comprising a plurality of tensioned tensile members attached to the wall determining a shape of the segment.

### CROSS-REFERENCE TO RELATED APPLICATION

The present application is a national stage of and claims priority of International patent application Serial No. PCT/EP2016/082895, filed Dec. 29, 2016, and published in English as WO 2017/114933 A1, the content of which is hereby incorporated by reference in its entirety.

### TECHNICAL FIELD

The present disclosure relates to the field of constructing shaft furnaces, in particular a metallurgical furnace such as a blast furnace. The construction may be part of original construction and/or of (partial) reconstruction, e.g. in the course of repair, refurbishment, renovation etc.

### BACKGROUND

A shaft furnace generally comprises a ring wall or shell extending along an axis. The wall is generally metallic, and provided with a protective lining on at least part of its inner surface so as to protect the wall from extreme temperatures and process conditions in the interior of the furnace in operation.

Customarily, in blast furnaces the cooling may be of the “stave cooler” type or of the “plate cooler” type. In each type, the lining comprises a refractory material.

In a stave cooler concept the refractory material and cooling elements are arranged in modules or “stave coolers” that are connected to the wall and extend substantially parallel to the wall. Spaces between adjacent staves and spaces between the staves and the wall are filled with mortar and/or other heat-resistant material.

In a plate cooler concept, the wall is provided with liquid-cooled plates which extend into the lining and which may be grouped in a plurality of horizontal planes. The lining is further formed predominantly from refractory elements arranged along the wall interspersed with the plate coolers. The refractory elements may be blocks generally stacked along the wall without mutual fixation other than their shape and stacking under gravity. Spaces between the wall and the refractory elements may be filled with mortar. Thermal contact between cooling elements and refractory material is essential for functionality and longevity of the lining.

The lining may wear. Staves are thought to survive several years. Plate cooler lining may survive significantly longer, even up to decades. Stave cooled furnaces must therefore be refurbished from time to time and such furnaces may be converted and reconstructed to a plate cooler type. For (re-) construction of shaft furnace, the wall may be assembled from wall portions pieced together to form the ring wall.

Downtime of a shaft furnace due to repair and/or other construction work must generally be kept to a minimum, this also holds for time of initial construction. Consequently, improvements in construction methods are sought after.

### SUMMARY

In an aspect, a method of constructing a shaft furnace, in particular a metallurgical furnace such as a blast furnace is provided herewith. The method comprises the steps of

providing on a first position a shaft furnace segment comprising a ring wall extending along a central axis, and

transporting the segment to a second position and operably attaching the segment there to one or more further shaft furnace portions.

The method further comprises that during said transporting the segment to the second position the segment comprises at least one fixation structure comprising one or a plurality of tensioned tensile members on an inside of the ring wall, attached to the wall determining a shape of the segment, preferably with respect to the axis substantially radial and/or tangential tensioned tensile members.

The fixation structure enables securing and/or maintaining a predetermined ring shape of the segment during the transport. Tensile structures may be lighter-weight than compression loaded structures such as carrying beams. Thus, an assembly comprising the segment and the fixation structure may be relatively light-weight for manipulation, even in the large sizes of blast furnaces (several meters in diameter and/or height, weighing several tens to hundreds of tons). Further, deformation due to (weight of) the fixation structure itself may be substantially prevented. Thus, the furnace may be constructed modularly, wherein a ring furnace segment wall may be installed in one go, so that the furnace is constructed of one or more rings. This may reduce construction time. Also, tensile members may be flexible, such as cables, chains etc. e.g. for storing and transporting in deformed, e.g. bundled and/or folded, shape.

In particular, the method comprises providing the segment with the at least one fixation structure before transporting the segment to the second position and removing the fixation structure(s) afterwards.

In an embodiment the fixation structure comprises a hub, at least some of the tensile members being attached to the hub. The hub may be arranged at or near the axis. A centrally arranged hub may facilitate arranging and/or tensioning the fixation structure or at least one or more of the tensile members. One or more of the tensile members may extend substantially radial or tangential with respect to the hub. It is conceivable that one or more of the tensile members extend between the hub and the wall with a small axial component, similar to spokes in a spoked wheel like a bicycle wheel.

In an embodiment at least some of the tensile members are attached to one or more sacrificial wall portions in the wall, wherein the method comprises, after said transporting the segment to the second position, e.g. in the second position of the segment, removing one or more of the sacrificial wall portions from the wall (hence the name sacrificial wall portion) thus providing an opening in the wall and attaching another element in the opening.

Thus, the tensile members are attached to wall sacrificial portions that are (to be) used for other elements later on in the furnace and the furnace is not thereafter affected by (remnants of) connectors for the tensile members. The attachment may be of simple construction and need not adhere to tight tolerances.

The method may comprise partially cutting and/or removing a sacrificial wall portion prior to transport and possibly prior to attaching a tensile element to the sacrificial wall portion. Thus, removal of the sacrificial wall portion may be prepared including detailing of future remaining wall portions which may take significant time and/or effort, whereas the actual removal may be facilitated.

For preparatory work, time may be of little constraint whereas, once the segment is in situ and removal of the sacrificial wall portions and/or the fixation structure are in order, process time may be of the essence.

In view of the latter considerations, the method may also comprise providing the segment in the first position with lining material, in particular refractory material elements, and transporting the segment to the second position together with the lining material. The segment is thus provided at the second position further in a further state of completion.

It is noted that the steps of providing the segment in the first position with lining material, in particular refractory material elements, and transporting the segment to the second position together with the lining material, may also be done without a reinforcement structure or with another type of reinforcement structure.

An embodiment may comprise fixing the lining material, in particular refractory material elements, to a fixation structure. Upon removal of the fixation structure the fixation of the lining material may be removed as well.

Fixing the lining material enables, and may comprise, establishment and/or preservation of a desired shape of the lining material e.g. alignment of lining material portions, such as refractory material elements, with respect to each other.

In a particular embodiment, the method comprises providing the segment with plural fixation structures attached at different axial positions to the wall and fixing lining material by clamping lining material between adjacent fixation structures. For that, one or more of the respective fixation structures may comprise a clamping structure which may be adjustable for establishing a desired clamping force and/or accommodating a particular lining shape. Clamping may obviate other fixation methods that may leave more or less permanent marks, e.g. bolting, welding and/or provision of an adhesive.

In an embodiment, a reinforcement structure is arranged in axial direction along the wall of the segment and comprises a clamping structure, which may be adjustable, for establishing a desired clamping force onto lining material, e.g. plate coolers and/or refractory material elements and/or accommodating a particular lining shape.

An embodiment of the method may comprise adjusting a shape of the segment somewhat by adjusting a length of and/or tension in one or more of the tensile members where present. In case of plural fixation structures, each may be used for adjustment of a partial shape, e.g. different cross sectional shapes at different axial positions. It is noted that by construction and/or by use a shaft furnace may become slightly deformed from a designed shape. With the present embodiment, the shape of the segment can be corrected and/or the shape of the segment can be accommodated to the actual shape of shaft furnace portions to which the segment is to be connected. The amount of correction possible in a certain case may depend on properties of the wall and/or a lining where present.

A fixation structure for use in the method and/or in the assembly described herein may comprise a tensile member for attachment to a ring wall portion extending in axial direction, the fixation structure comprising a clamp for exerting a clamping force in substantially axial direction at or near the wall, e.g. for clamping onto refractory material elements when the tension member is tensioned.

It is noted that reconstructing a shaft furnace by using pre-assembled segments incorporating refractory blocks and plate coolers has not previously been performed. A reason for this is that the stability of the refractory lining and the stability of the lining assembly and relevant installation tolerances could not be guaranteed in case of pre-assembled segments. The presently provided techniques address this issue and facilitate such reconstruction.

In accordance with the above, an aspect comprises an assembly comprising a shaft furnace segment, in particular a segment for a metallurgical furnace such as a blast furnace, comprising a ring wall extending along a central axis and comprising at least one fixation structure. The fixation structure comprises one or preferably a plurality of tensioned tensile members on an inside of the ring wall, attached to the wall, preferably with respect to the axis substantially radial and/or tangential tensioned tensile members, attached to the wall and configured to determine a shape of the segment. The shape of the segment can be defined and/or maintained during transportation due to the fixation structure. It is noted that annular objects such as a tubular ring wall segment may become stronger when subject to compressive forces which may be provided by the fixation structure, e.g. adjusting tension in the tensile members.

The fixation structure may comprise a hub, at least some of the tensile members being attached to the hub. The hub may be located centrally with respect to the segment, e.g. being centred around the axis. Note that the segment and the hub may be, but do not need to be, round as basic ring shape.

At least some of the tensile members may be attached to one or more sacrificial wall portions in the wall, the one or more sacrificial wall portions preferably comprising and/or being defined by at least partly pre-cut wall portions, the wall comprising one or more mounts for attachment of an element fit in a wall opening provided by removal of the sacrificial wall portion. This facilitates removal of the fixation structure from the segment.

In an embodiment, the segment may comprise cooling elements, in particular plate coolers. Assembly of the cooling elements may be done on another location than there where the segment is to be used. This reduces time for mounting the segment in situ.

Similarly, the segment may comprise refractory material elements.

In an embodiment, the assembly may comprise plural such fixation structures attached at different axial positions to the wall and refractory material elements may be fixed, e.g. clamped, between adjacent fixation structures, for transporting the segment to the second position together with the refractory material elements.

In an embodiment, at least one of the fixation structures comprises one or more adjustable clamps for exerting a clamping force in substantial axial direction at or near the wall, e.g. for clamping onto refractory material elements.

Further, tensile members may be provided for adjustable tension and be readily removed by relaxation of the tension.

Different aspects and/or embodiments of the disclosure exhibiting one or more of the described benefits are presented in the following:

An aspect is a method of constructing a shaft furnace, in particular a metallurgical furnace such as a blast furnace, comprising the steps of

providing on a first position a furnace segment comprising a ring wall portion extending along a central axis, and

transporting the segment to a second position and operably attaching the segment there to one or more further shaft furnace portions;

wherein the method further comprises the steps of:

providing the segment in the first position with refractory material elements along an inside of the ring wall portion and/or adjusting a position of such refractory material elements along an inside of the ring wall portion;

providing at least one fixation structure comprising a plurality of tensioned tensile members attached to the wall, and

fixing the refractory material elements with respect to the wall with the fixation structure; and

wherein the step of transporting the segment to a second position comprises transporting the segment to the second position together with the refractory material elements.

In another aspect an assembly comprises a shaft furnace segment, in particular a segment for a metallurgical furnace such as a blast furnace, comprising a ring wall portion extending along a central axis and comprising refractory material elements along an inside of the ring wall portion, the segment further comprising at least one fixation structure,

wherein the fixation structure comprises a plurality of tensioned tensile members attached to the wall fixing the refractory material elements with respect to the wall.

Another aspect is a fixation structure for use in the method and/or the assembly described herein, comprising a tensile member for attachment to a ring wall portion extending in axial direction, the fixation structure comprising a clamp for exerting a clamping force in substantially axial direction at or near the wall, e.g. for clamping onto refractory material elements when the tension member is tensioned, which may be done by tensioning the tensile member.

### BRIEF DESCRIPTION OF THE DRAWINGS

The above-described aspects will hereafter be more explained with further details and benefits with reference to the drawings showing a number of embodiments by way of example.

FIG. 1 shows an assembly comprising a blast furnace segment and two fixation structures.

FIGS. 2-3 are perspective and side views, respectively, of the assembly of FIG. 1, partly cut away as indicated.

FIG. 4 is a detail view of FIG. 2 as indicated with Roman numeral IV.

FIGS. 5, 6, 6A, and 7 are different views of another embodiment of an assembly comprising a blast furnace segment and a fixation structures.

FIGS. 8-11 indicate method steps of an embodiment of constructing a shaft furnace.

FIG. 12 shows a detail of another embodiment in cross section view.

### DETAILED DESCRIPTION OF EMBODIMENTS

It is noted that the drawings are schematic, not necessarily to scale and that details that are not required for understanding the present invention may have been omitted. The terms “upward”, “downward”, “below”, “above”, and the like relate to the embodiments as oriented in the drawings, unless otherwise specified. Further, elements that are at least substantially identical or that perform an at least substantially identical function are denoted by the same numeral, where helpful individualised with alphabetic suffixes or primes (′, ″).

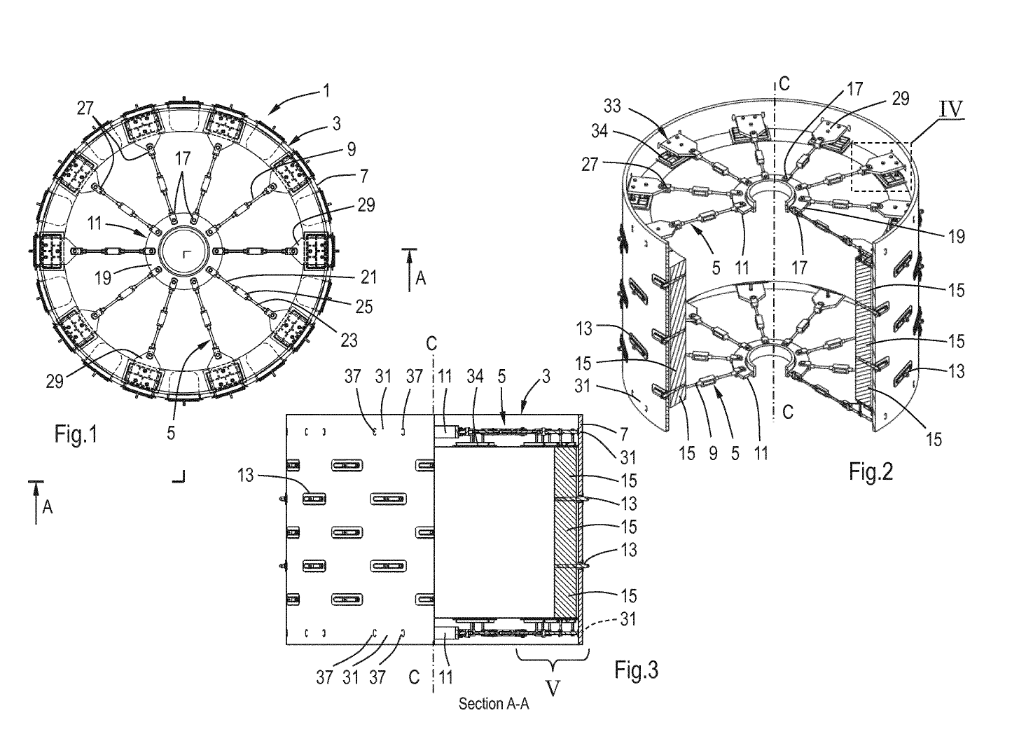

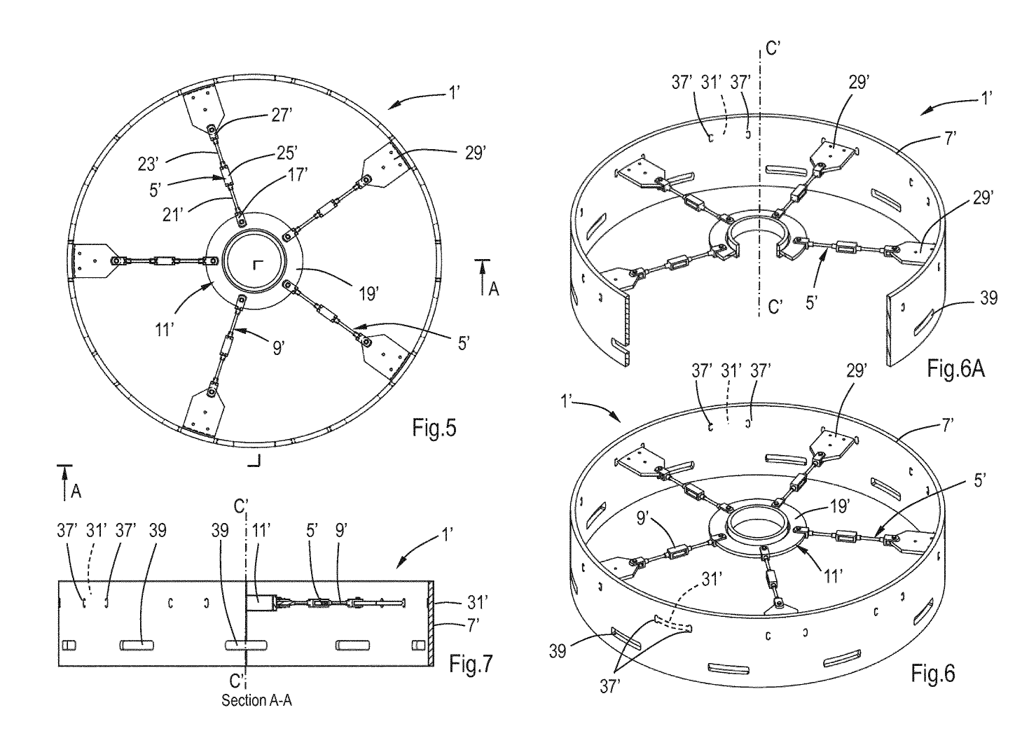

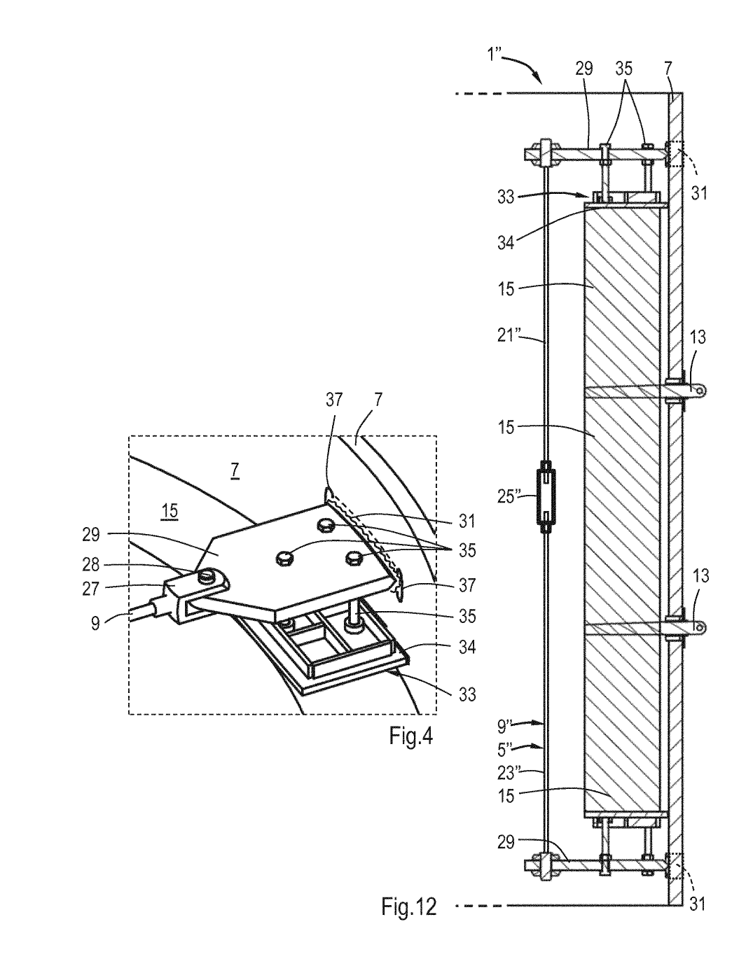

FIG. 1 shows a top view of an assembly 1. FIGS. 2-3 are perspective and side views, respectively, of the assembly 1, partly cut away along path A-A indicated in FIG. 1. FIG. 4 is a detail view of FIG. 2, as indicated with “IV”. The assembly 1 comprises a blast furnace segment 3 and two fixation structures 5 attached to the wall 7 near the top and bottom of the segment 3, respectively. The fixation structures 5 may be called nets, spiders and/or spider webs.

The segment 3 comprises a ring wall 7 which is to become part of a blast furnace shell. Here, the wall 7 is generally round in cross section with a substantially constant shape and size but another embodiment the wall may be of varying diameter e.g. (frusto-)conically or so that the wall is somewhat bulging. The segment extends along central axis C. Generally, in use the axis C will extend vertical and the wall 7 will have a bottom rim and an upper rim. The fixation structure extends between the bottom rim and an upper rim, and preferably not beyond them, in particular extending from a position at or near the bottom rim to a position at or near the upper rim, and it preferably leaves the bottom rim and an upper rim free for attachment to other furnace portions.

The fixation structures 5 each comprise a plurality of, with respect to the axis C, substantially radial tensile members 9 attached to the wall 7 on one side and to an optional hub 11 on another side. Here, the fixation structures 5 are arranged and shaped substantially symmetrically about the axis C. In another embodiment, not shown, tensile members 9 may extend generally tangential to the segment wall 7 and/or the axis C, like a chord to the round shape of the segment wall 7, preferably also arranged and shaped substantially symmetrically about the axis C.

The shown segment 3 comprises, in the shown example, a number of plate coolers 13—known per se—extending through the wall 7 generally radial forming generally horizontal rings of plate coolers around the segment 3. The plate coolers are liquid-coolable by flowing cooling liquid through the plates. Further, a layer of refractory material elements 15 is arranged along the wall 7. Thus a lining is formed to the segment 3.

Referring now also to FIG. 4, it may be seen that the tensile members 9 in the shown embodiment are of a rod-type, although cables, chains etc. are possible, and comprise an optional connector 17 to connect to (a flange 19 on) the hub 11, a first portion 21 and a second portion 23 interconnected with an optional spanner 25, for length adjustment of the member 9, e.g. here by screwing the spanner 25 about threads on the first and second portions 21, 23, but other types of spanner, e.g. a winding spanner with a ratchet spindle, are possible too.

The tensile members 9 are attached to the wall 7 of the segment 3, here via optional connectors 27 and tongues 29. Here the connectors 17, 27, are formed as jaws with a lock bolt 28 fitting (holes in) the flange 19 and tongue 29, respectively. The tongues 29 extend from the wall 7 proper, here being attached to wall portions 31 by welding. The tongues 29 may have another shape and adjacent tongues 29 may be interconnected forming a frame portion. The wall portions 31 are sacrificial portions: once the fixation structure 5 is no longer required the wall portions 31 are cut out of the wall 7. In the thus-formed openings in the wall 7 further plate coolers 13 or other objects may be mounted and intervening spaces between the plate coolers 13 or other objects may be closed by insertion of further refractory blocks 15.

The refractory blocks 15, which may be of various suitable compositions as schematically indicated, may be stacked loose to the wall 7, i.e. without particular fixation other than shape and gravity. In order to reduce or prevent movement of the refractory blocks 15, the tongues 29 are provided with adjustable clamps 33 for exerting a clamping force in substantial axial direction at or near the wall 7, e.g. for clamping onto refractory material elements 15.

Here, the clamps 33 comprise pressing plates 34, of which the position, orientation, force and/or direction, relative to the tongues 29, may be adjusted via mounting bolts 35, for allowing adjusting associated aspects of the clamping force onto the refractory blocks 15. However, other adjustment systems like ratchets, scissor jacks etc. may be employed also. It is noted that accurate positioning of the refractory material elements 15 and plate coolers 13 with respect to each other is very relevant for proper functioning of a blast furnace. It is considered that millimeter tolerances and sub-millimeter tolerances like 0.5 mm or less may be achievable with transporting the assembly including refractory material elements 15 and plate coolers 13 of height and/or diameter sizes of less than a meter and up to tens of meters and weights in a range of and tens to hundreds of tons or even a thousand tons.

It is noted that very tight manufacturing tolerances and installation tolerances in the range of 0.5 mm and less should generally be adhered to for blast furnaces in order to meet standards and requirements for safety and robustness. The presently presented techniques enable this without post-processing or at least without significant post processing of the transported assembly.

To facilitate removal of the sacrificial wall portions 31, parts thereof may be pre-cut (FIGS. 2-3): e.g. here, the finished openings for the plate coolers 13 should have rounded ends 37, whereas between the rounded ends the openings have generally straight sides, and the rounded ends 37 are pre-cut into the wall 7 so that after placement of the segment 3 only the relatively simple action of cutting the straight edges remains. Thus, time for final assembly of a blast furnace with the segment 3 is reduced. Note that also or alternatively other shapes may be pre-cut into the wall and/or other preparatory measures may be taken so as to reduce the time for final processing and/or assembly in situ in the furnace under construction (see below). It is noted that mounting of parts, e.g. the plate coolers 13 into the wall 7 fortify the wall somewhat relative to the holey structure of the wall being penetrated by the large number of openings desired for high power cooling of the lining.

FIGS. 5-7 are different views of (part of) another embodiment of an assembly 1′ comprising a blast furnace segment 3′ and a fixation structure 5′. The basic structure of this segment 3′ and of the fixation structure 5′ are similar to that of the embodiment of FIGS. 1-4 (compare reference numerals). However, here the wall 7′ is lower and it is not yet provided with plate coolers or refractory blocks, but openings 39 for them (here: two rings of plate coolers) are present. In some places sacrificial wall portions 31′ are left, recognisable from pre-cuts 37′, for attachment of the fixation structure 5′. In this embodiment clamps are absent and the tongues 29′ are of simpler construction than discussed above.

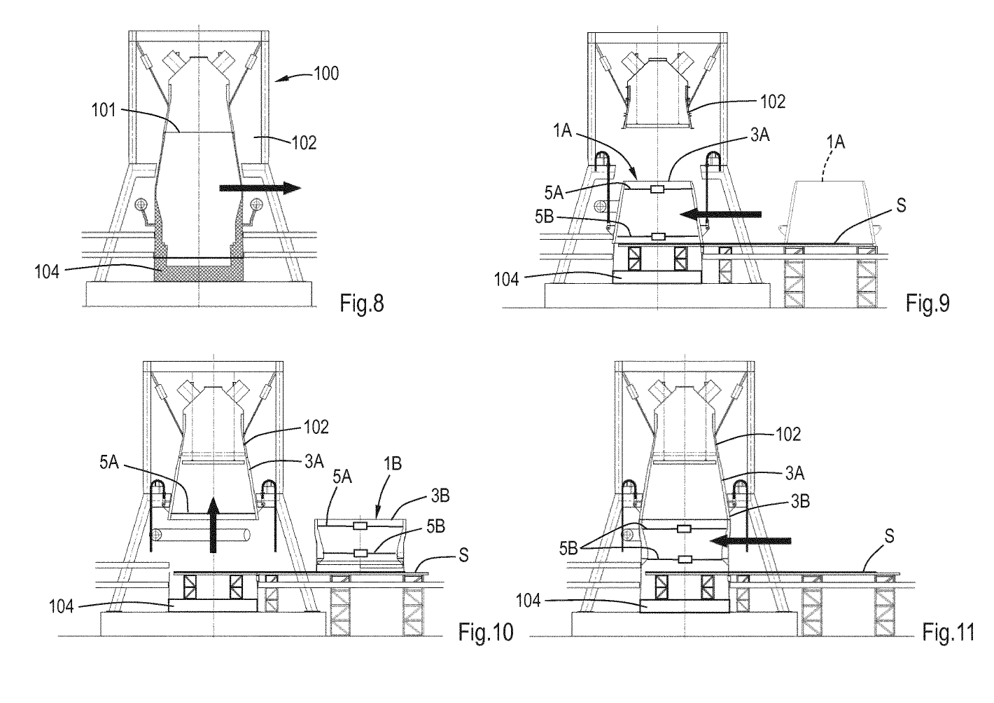

A method of constructing a blast furnace, wherein the construction comprises refurbishment of a blast furnace is indicated in FIGS. 8-11. From an existing blast furnace 100, a segment is 101 is removed (FIG. 8, see arrow). The bottom and top portions 102, 104 are retained and appropriately supported. During or before these actions, a replacement segment 3A is positioned and assembled with fixation structures 5A next to the furnace 100, here on an elevated working support S. Then the assembly 1A of segment 3A and fixation structures 5A is transported over the support S to (the remainder of) the blast furnace 100 (FIG. 9, see arrow). The assembly 1A is then lifted and attached to the remaining top portion 102 of the blast furnace 100 (FIG. 10, see arrow), typically by welding the respective walls of the top portion 102 and the segment 3A together. Before the attachment, tension in one or more of the tensile members of the fixation structures 5A may be adjusted to conform the segment 3A to the top portion 102. After attachment, one or both fixation structures may be removed from the segment 3A (FIG. 10)

These steps are repeated with another assembly 1B of a blast furnace segment 3B with fixation structures 5B which is attached to the first segment 3A (FIGS. 10-11, see arrows).

Next, the support S is removed and a small segment acting as a closing ring, e.g. see FIGS. 5-7, is inserted in the space left by the support S and attached to the other parts of the refurbished blast furnace (not shown) to provide a closed shell. For finishing the blast furnace, remaining fixation structures and/or sacrificial wall portions are removed and the lining is completed by mounting of missing plate coolers and filling voids with refractory material, which may comprise mortar and/or refractory castable, and other connections are finished.

FIG. 12 shows, in cross section, part of another assembly 1″ comprising a blast furnace segment 3 and a fixation structure 5″ (cf. the right-hand side of the cross section plane of FIGS. 2 and 3). The basic structure of this segment 3 is like that of the embodiment of FIGS. 1-4 (compare reference numerals). However, here the fixation structure 5″ differs in that it comprises a tensile member 9″ extending substantially in axial direction and parallel to the wall 7 of the segment 3. The tensile member 9″ is connected (here: bolted) on opposite sides to two tongues 29 welded to sacrificial wall portions 31. Clamps 33 for clamping refractory elements 15 are mounted to the tongues 29. In this embodiment, the clamping force onto refractory elements 15 may be adjusted by adjustment of the clamping plates 34 with respect to the tongues 29 and/or by adjustment of tension in the tensile member 9″, e.g. by adjusting a spanner 25″ threaded onto first and second tension member portions 21″ and 23″, respectively, in which case adjustability of the clamp 33 may be omitted allowing a simpler clamp design.

Due to the fixation structures, assemblies of wall segments complete with significant amounts of lining material may be assembled on the support S and be transported to their final place (e.g. FIGS. 8-11) with no or at least acceptable deformation. Total downtime of a blast furnace refurbishment may then be determined substantially only by the time frame for cutting the furnace, removing the unwanted segments, inserting the new segments and finishing the lining at or near the attachment zones where the segments are attached together. Initial calculations show that for refurbishment and conversion of an existing stave-cooled blast furnace to a plate-cooled blast furnace the down time may be reduced by about 20 days by obviating in-situ installation of the lining, in particular stacking of the refractory blocks

The disclosure is not restricted to the above described embodiments which can be varied in a number of ways within the scope of the claims. For instance, more, less and/or differently shaped segments may be used for (re-)construction of a furnace. In a fixation structure, more, less and/or differently shaped tensile members may be provided. Fixation structures may be interconnected, e.g. hubs of adjacent fixation structures may be interconnected, and radial fixation structures may be combined with one or more axial fixation structures, e.g. the embodiments 5 and 5″ of FIGS. 1-4 and FIG. 12, respectively may be combined, wherein differently oriented tensile members 9 and 9″ may be connected to a single tongue 29. A segment may be constructed from sub-assemblies. Different fixation structures may differ with respect to the number, arrangement, design and/or construction of their tensile members. A tensile member may be branched, e.g. having an “X”- or “Y”-shape. Connectors of the tensile members may differ, e.g. being wire loops and/or shackles. Further supports and/or clamps for adjusting and/or fixing lining material may be provided, e.g. attached as insert mounts connected to openings for (future) plate coolers and/or other objects.

Elements and aspects discussed for or in relation with a particular embodiment may be suitably combined with elements and aspects of other embodiments, unless explicitly stated otherwise.

1. A method of constructing a shaft furnace, comprising:
providing on a first position a shaft furnace segment comprising a ring wall extending along a central axis, and
transporting the segment to a second position and operably attaching the segment there to one or more further shaft furnace portions;
wherein during said transporting the segment to the second position the segment comprises at least one fixation structure comprising one or more tensioned tensile members on an inside of the ring wall, attached to the wall determining a shape of the segment.

2. The method of claim 1, wherein the fixation structure comprises a hub, at least some of the tensile members being attached to the hub.

3. The method of claim 1, wherein at least some tensile members are attached to one or more sacrificial wall portions in the wall,
wherein the method comprises after said transporting the segment to the second position removing a sacrificial wall portion from the wall thus providing an opening in the wall and attaching another element in the opening.

4. The method of claim 3, wherein the another element comprises a cooling element.

5. The method of claim 1, comprising providing the segment in the first position with lining material and transporting the segment to the second position together with the lining material.

6. The method of claim 5, comprising fixing the lining material to the fixation structure.

7. The method of claim 6, wherein the method comprises providing the segment with plural such fixation structures attached at different axial positions to the wall and fixing the lining material by clamping the lining material between adjacent fixation structures.

8. The method of claim 1, comprising adjusting a shape of the segment by adjusting a length of and/or tension in or more of the tensile members.

9. An assembly comprising a shaft furnace segment comprising a ring wall extending along a central axis and comprising at least one fixation structure,
wherein the fixation structure comprises one or more tensioned tensile members on an inside of the ring wall attached to the wall and configured to determine a shape of the segment.

10. The assembly of claim 9, wherein the fixation structure comprises a hub, at least some tensile members being attached to the hub.

11. The assembly of claim 9, wherein at least some tensile members are attached to one or more sacrificial wall portions in the wall, the wall comprising one or more mounts for attachment of an element fit in a wall opening provided by removal of the sacrificial wall portion.

12. The assembly of claim 9, wherein the segment comprises cooling elements and/or refractory material elements.

13. The assembly of claim 9, comprising one or more fixation structures attached at different axial positions to the wall and wherein refractory material elements are fixed by the fixation structures for transporting the segment to the second position together with the refractory material elements.

14. The assembly of claim 9, wherein at least one of the fixation structures comprises one or more adjustable clamping portions for exerting a clamping force in substantial axial direction at or near the wall.

15. A fixation structure for use in the method of claim 1, comprising a tensile member for attachment to a ring wall portion extending in axial direction, the fixation structure comprising a clamp for exerting a clamping force in substantially axial direction at or near the wall, e.g. for clamping onto refractory material elements when the tensile member is tensioned.

16. The assembly of claim 11, wherein the one or more sacrificial wall portions comprise and/or being defined by at least partly pre-cut wall portions.

17. The assembly of claim 9, wherein the one or more tensioned tensile members are substantially radial and/or tangential tensioned tensile members with respect to the axis.

18. The assembly of claim 13 wherein the refractory material elements are fixed by the fixation structures between adjacent fixation structures.

19. The method of claim 3, and further comprising partially cutting and/or removing one or more of the sacrificial wall portions prior to attaching a tensile element to the sacrificial wall portion.

20. The method of claim 1, wherein the one or more tensioned tensile members are substantially radial and/or tangential tensioned tensile members with respect to the axis.
